(19) United States
(12) Patent Application Publication
(10) Pub. No.: US 2010/0236459 A1
(43) Pub. Date: Sep. 23, 2010

(54) METHOD FOR DETERMINING THE FOSSIL FUEL CONTENT IN A FUEL STREAM, AS WELL AS AN INCINERATION FURNACE

(75) Inventors: Fredericus Petrus Bakker, Beverwijk (NL); Marco Geusebroek, Petten (NL)

Correspondence Address: YOUNG & THOMPSON, 209 Madison Street, Suite 500, Alexandria, VA, 22314, US

(73) Assignee: STICHTING ENERGIEONDERZOEK CENTRUM NEDERLAND, Petten (NL)

(21) Appl. No.: 12/739,749

(22) PCT Filed: Oct. 22, 2008
(86) PCT No.: PCT/NL2008/050662

§ 371 Date: Apr. 26, 2010

(30) Foreign Application Priority Data
Oct. 24, 2007 (NL) 2000960

(51) Int. Cl. F23G 5/00; G01F 1/78

(52) U.S. Cl. 110/235; 73/861.351

(57) ABSTRACT

Method and device for determining the fossil fuel content in a fuel stream fed to an incineration furnace. According to the method, the waste gas is sampled and the amount of “new” and “old” carbon present in the CO₂ is determined by the ¹⁴C method. When the stream of waste gas varies, an accurate measurement can be achieved by measuring the quantitative throughput of gas using a mass or volume flow meter and relating this to the size of the sample.

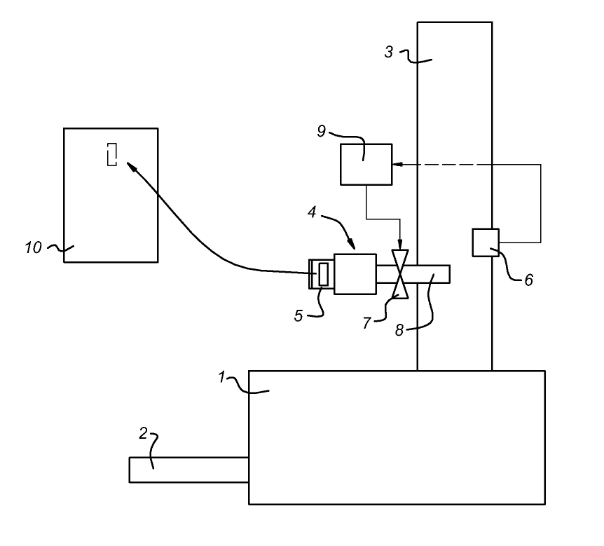

The present invention relates to a method for determining the fossil fuel content in a fuel stream fed to an incineration furnace according to the preamble of Claim 1.

Various kinds of material are fed to incineration furnaces, for the most part fossil fuels, that is to say fuels which are tens of thousands of years old and older. In particular in the case of waste incinerators, but also with other incineration furnaces, a fuel stream is also supplied which comprises fuels which are less old. Examples thereof are wood, rubber material and the like. These fuels are also referred to as biogen fuels.

For environmental reasons, it is desirable to limit the emission of the greenhouse gas CO₂ as much as possible, in particular the CO₂ which is generated during the combustion of fossil fuels. Combustion of carbon which has been converted to, for example, wood relatively recently is not considered to be polluting. After all, wood is only a few tens to hundreds of years old and is the result of the conversion of carbon dioxide from the atmosphere into carbon.

In certain countries, charges have even been introduced for the emission of fossil fuel, that is to say fuel which originated more than 10,000 years ago.

If a mixed fuel stream is fed to an incineration furnace, it is important to know which fraction of the supplied fuel is fossil and which fraction of the fuel is more recent.

One possibility of determining this is through the analysis of the stream which is supplied.

Such a method is inaccurate when only random checks are carried out. In addition, it requires highly experienced investigators and/or is complicated.

A method for producing fuel from waste is known. It uses sampling and the fossil fuel content is determined by combusting CO₂ and using the C-14 method.

WO-A-02/06730 describes a method for determining the relationship between fossil and non-fossil energy carriers in a fuel mixture.

It is an object of the present invention to provide a simplified method in which the ratio between fossil and biogen fuels can be determined accurately.

This object is achieved with the above-described method using the features of Claim 1.

According to the present invention, the amount of ¹⁴C which is present is used to analyze the composition of the waste gas. The CO₂ which is present therein partly consists of CO₂ originating from fossil fuels and partly of CO₂ originating from biogen fuels.

¹⁴C is a radioactive element having a half-life of approximately 5700 years, which means that within said period, half the ¹⁴C content of any organic material which does not take part in the carbon cycle will disappear. In other words, all ¹⁴C will have disappeared within 60,000 years if the respective carbon is/was stored underground. In other words, in fossil fuels the ¹⁴C content is zero while in more recent biogen fuels it is approximately 1 ppt (10⁻¹²).

By determining the ¹⁴C content, the amount of non-fossil and biogen fuel, respectively, is known. If the total CO₂ percentage is known, the amount of fossil fuel in a sample can be calculated in a simple manner. Using the results, it is possible to determine, for example, charges and the like.

The accuracy of the method can be improved if a relationship is established between the sampled amount and the amount of discharged gas. This applies in particular in the case of varying amounts of discharged gas. This relationship is preferably linear, that is to say that the variation in the sampling is directly proportional to the variation in the amount of discharged gas.

There are various techniques for determining ¹⁴C. The most important technique which can be used in practice with the above-described method is the liquid scintillation counting (LSC) which allows very accurate measurements, for example having a relative standard deviation of less than 1% with samples which contain at least 25% of biogen mass. However, it is also possible to obtain good results with very low contents of non-fossil fuel, that is to say 5% or less. Other methods for determining ¹⁴C are β-ionization (gas burners) and accelerated mass spectrometry (AMS). For determining the total stream of waste gas or flue gas, a mass flow monitor can be used.

The invention also relates to an incineration furnace comprising an inlet for a fuel stream and an outlet for the discharge of waste gases, wherein a sampling device is arranged in said outlet, said sampling device comprises a sampling container, having an inlet which can be connected to said outlet for receiving said waste gases, with said sampling device being provided with a valve for said inlet and a valve control, wherein a sensor is provided in said outlet which is connected to said valve control for determining the total amount of waste gases, wherein said valve control controls the size of the valve opening to said inlet depending on the total waste gas stream which has been measured by the sensor.

It will be understood that, instead of a structure having a valve and valve control, any other structure can be used in which a relationship is established between the amount of waste gases which is emitted and the extent of the sampling.

Such an incineration furnace may, for example, comprise the furnace of a household waste incineration furnace. Other applications, such as in the production of cement and in power plants, are also possible.

The invention also relates to an assembly comprising an incineration furnace as described above in combination with a ¹⁴C-determining device. The ¹⁴C-determining device will generally be a laboratory which is situated at a distance from the incineration furnace. The sampling container can be removed at regular intervals from the flue gas outlet and replaced with another sampling container, with the first sampling container being taken to the ¹⁴C-determining device.

The invention will be described below with reference to an exemplary embodiment illustrated in the drawing.

Therein, the single FIGURE diagrammatically shows an embodiment of the present invention.

In the FIGURE, an incineration furnace is denoted by reference numeral 1. As has been indicated above, this may comprise any kind of incineration furnace, but is preferably an incineration furnace which can be fed with fuel streams of varying composition. Examples are household waste incineration furnaces and furnaces which are used in calcination, for example for preparing cement.

The incineration furnace 1 comprises an inlet 2 for fuel. This fuel may comprise fossil fuel and non-fossil fuel. Examples of this non-fossil or biogen fuel are wood, packaging materials, paper, household vegetable waste, manure, slaughter waste, certain kinds of plastics, (car) tyres and the like.

The incineration furnace is provided with a chimney or outlet 3. The chimney contains a sampling device 4 and a mass flow meter 6. The sampling device comprises an inlet 8 in which a valve 7 and a sample container 5 are arranged.

At a distance from the waste incineration furnace, a sample-determining device is provided, which is denoted overall by reference numeral 10. The latter may, for example, be situated in a laboratory and is capable of determining ¹⁴C by means of the liquid scintillation method.

A valve control 9 is present which controls opening and closing of the valve 7 based on the signal originating from the mass flow meter 6.

The above-described device functions as follows:

When burning fuel in the incineration furnace 1, a sample is taken continually or in any other intermittent way and placed in sample container 5. Sample container 5 is periodically replaced and the sample obtained using sample container 5 is analysed for ¹⁴C in analyzing device 10. Depending on the amount of gas which flows through the chimney 3, and which is determined by the mass flow meter, the shut-off valve 17 is opened proportionally. That is to say, when a large amount of waste gas flows through, a large amount of material passes through the inlet 8. As a result of this proportional method, it is possible to obtain very accurate measurement results. This is particularly important when the amount of gas which flows through the chimney 3 varies.

Upon reading the above, those skilled in the art will immediately be able to think of variants which are within the scope of the present invention. Thus, it is possible to design the sample-determining device 10 in another manner. All that is important is that the latter is able to determine the biogen and fossil carbon content using the ¹⁴C method.

Depending on the application, either the fossil carbon content or the non-fossil carbon content, or both, are determined.

The above-described variants are obvious to those skilled in the art upon reading the above and are within the scope of the attached claims.

1-9. (canceled)

10. A method for determining the fossil fuel content in a fuel stream fed to an incineration furnace (1), said method comprising sampling the waste gas stream, determining the carbon content in the CO₂ which originates from non-fossil fuel, using a ¹⁴C method for determining the proportion of non-fossil carbon, said sampling comprising determining the total amount of waste gases and, depending on said total amount of waste gases, supplying an amount of waste gases to said sampling.

11. The method according to claim 10, wherein said fuel stream comprises portions of waste material.

12. The method according to claim 10, wherein the size of the sample is directly proportional to the size of the total waste gas stream.

13. The method according to claim 10, wherein a mass flow monitor is used for measuring the total waste gas stream.

14. An incineration furnace comprising an inlet for a fuel stream and an outlet for the discharge of waste gases, wherein a sampling device is arranged in said outlet, said sampling device is embodied to determine the non-fossil fuel content of the fuel stream and comprises a sampling container, having an inlet which can be connected to said outlet for receiving said waste gases, said sampling device being provided with a valve for said inlet and a valve control, wherein a sensor is provided in said outlet which is connected to said valve control for determining the total amount of waste gases, wherein said valve control controls the size of the valve opening to said inlet depending on the total waste gas stream which has been measured by the sensor.

15. The furnace according to claim 14, wherein said incineration furnace comprises a household waste incineration furnace.

16. The furnace according to claim 14, wherein said incineration furnace comprises a part of a cement-producing device.

17. An assembly comprising an incineration furnace comprising an inlet for a fuel stream and an outlet for the discharge of waste gases, wherein a sampling device is arranged in said outlet, said sampling device is embodied to determine the non-fossil fuel content of the fuel stream and comprises a sampling container, having an inlet which can be connected to said outlet for receiving said waste gases, said sampling device being provided with a valve for said inlet and a valve control, wherein a sensor is provided in said outlet which is connected to said valve control for determining the total amount of waste gases, wherein said valve control controls the size of the valve opening to said inlet depending on the total waste gas stream which has been measured by the sensor and a ¹⁴C-determining device, wherein said ¹⁴C-determining device is embodied to accommodate said sampling container

18. The assembly according to claim 17, wherein said ¹⁴C-determining device comprises a liquid scintillation device.

19. The furnace according to claim 15, wherein said incineration furnace comprises a part of a cement-producing device.
